(19) United States
(12) Patent Application Publication
(10) Pub. No.: US 2022/0373397 A1
(43) Pub. Date: Nov. 24, 2022

(54) Entanglement-Enhanced Interferometers

(71) Applicant: The Regents of the University of Colorado, a body corporate, Denver, CO (US)

(72) Inventors: Juliet T. Gopinath, Boulder, CO (US); Greg Krueper, Boulder, CO (US); Lior Cohen, Denver, CO (US)

(21) Appl. No.: 17/742,277

(22) Filed: May 11, 2022

Related U.S. Application Data
(60) Provisional application No. 63/186,925, filed on May 11, 2021.

(51) Int. Cl. G01J 9/02; G02F 1/365; G02F 1/35; G02F 1/39; G02F 1/355

(52) U.S. Cl. CPC G01J 9/02; G02F 1/365; G02F 1/3536; G02F 1/395; G02F 1/3558; G02F 1/3503; G02F 2202/20; G01J 2009/0226; G01J 2009/0261; G01J 2009/0288

(57) ABSTRACT

An entanglement-enhanced interferometry system includes a source of correlated photons configured to two-mode squeezed vacuum (TMSV), a polarizing splitter or off-axis polarizing coupler configured to separate the correlated photons into two paths, a polarization control device configured to rotate polarization of photons on one of the two paths relative to the photons on the other of the two paths in order to make photons indistinguishable, a coupler configured to entangle the indistinguishable photons, and a polarization maintaining fiber-based interferometer configured to use the entangled photons as the input state. The source of correlated photons might be a nonlinear element such as a periodically poled element such as a lithium niobate bulk crystal or waveguide. The interferometer might be a Mach-Zehnder or a common path configuration. The coupler might be a 50:50 coupler or a polarizing coupler 45 degrees off-axis.

This application claims the benefit of and incorporates U.S. provisional application No. 63/186,925 filed 11 May 2021 and entitled “Entanglement-Enhanced Interferometers.”

This invention was made with government support under grant number DE-AR0001152 awarded by the U.S. Department of Energy. The government has certain rights in the invention.

### BACKGROUND OF THE INVENTION

### Field of the Invention

The present invention relates to improvements in entanglement-enhanced interferometers. In particular, the present invention relates to such interferometers implemented in fiber and using a two-mode squeezed-vacuum state.

### Discussion of Related ArtT

Currently, experimental imperfections have prevented entanglement-enhanced interferometers from demonstrating a significant quantum advantage in sensitivity. A general metric for a quantum advantage is to exceed the shot noise limit of light, where sensitivity scales as n^{-1/2}, where n is the average number of photons used in the system. With entangled states of light, it is possible to reach the Heisenberg limit, where sensitivity scales as n⁻¹, which is a √n enhancement. However, practical implementations of this technique remain elusive, due to obstacles such as optical losses, detection efficiency, and the fidelity of input state generation.

### SUMMARY OF THE INVENTION

In an embodiment, a fiber-based Mach-Zehnder interferometer, having imperfections in internal loss, detector efficiency, imperfect entanglement, and external phase noise, uses the two-mode squeezed vacuum (TMSV) as the input state to demonstrate a practical source of entanglement with 50 times more photon flux than a typical entangled photon source, allowing for faster measurements. A phase sensitivity 28% beyond the shot noise limit is feasible with current technology and realistic conditions, for example 81% efficiency. This system will be useful in remotely probing any system where any higher optical power would perturb or destroy the system.

Recent advances in quantum optical technology allow for fiber-based entanglement-enhanced interferometry to show a true quantum advantage, without post-selection, under realistic conditions. The present invention shows that, under 90% internal transmission, 90% detection efficiency, 2 mrad of phase noise, and 95% visibility, 2, 4, and 6-photon Holland-Burnett states show a 14%, 26%, and 28% sensitivity improvement beyond the shot-noise limit, on a per-photon basis. When superimposed into a two-mode squeezed vacuum state, these states show a 28% sensitivity improvement while also allowing for 50 times the photon flux of typical entangled-photon sources, which allows for faster measurements. This method may be useful for any photon-starved application, such as probing photosensitive or atomic samples, or in the transfer of information between quantum systems.

A fiber optic entanglement-enhanced interferometry system includes a source of correlated photons configured to two-mode squeezed vacuum (TMSV), a polarizing coupler configured to separate the correlated photons into two fiber paths, a polarization control device configured to rotate polarization of photons on one of the two fiber paths relative to the photons on the other of the two fiber paths in order to make photons indistinguishable, a coupler configured to entangle indistinguishable photons, and a polarization maintaining fiber-based interferometer configured to use the entangled photons as the input state.

An embodiment of the fiber optic entanglement-enhanced interferometry system includes a source of correlated photons configured to two-mode squeezed vacuum (TMSV), a polarizing splitter configured to separate the correlated photons into two paths, a polarization control device configured to rotate polarization of photons on one of the two paths relative to the photons on the other of the two paths in order to make photons indistinguishable, a coupler configured to entangle the indistinguishable photons, and a polarization maintaining fiber-based interferometer configured to use the entangled photons as the input state. Such systems can achieve a 28% improvement with 81% efficiency. Lower efficiencies (>70%) still achieve a significant improvement of around 10% to 28%.

The source of correlated photons might be silica optical fiber configured to facilitate spontaneous four-wave mixing. The source of correlated photons might be a nonlinear element configured to facilitate spontaneous parametric down-conversion The nonlinear element might be a periodically poled element, for example a lithium niobate bulk crystal or waveguide. The interferometer might be a Mach-Zehnder or a common path configuration. The coupler might be a 50:50 coupler or a polarizing coupler 45 degrees off-axis where the entanglement is implemented with polarization. An example is a two-axis polarization maintaining fiber. Detectors are capable of resolving the photon number of the state.

### BRIEF DESCRIPTION OF THE DRAWINGS

FIG. 1A is a schematic block diagram of an entanglement-enhanced interferometer system using two-mode squeezed vacuum according to the present invention.

FIG. 1B shows an expanded portion of the block diagram of FIG. 1A showing the Mach-Zehnder interferometer with more details.

FIG. 1C is a block diagram illustrating a common-path version of the interferometer of FIG. 1.

FIG. 2 is a plot showing phase sensitivity as a function of system efficiency for the first few Holland-Burnett states.

FIGS. 3A-3G show which photon detection events result in the most phase information for each Holland-Burnett states, including an assumed limitation of up to 6-photon number resolution on the detectors. FIG. 3A shows the 2-photon entangled state. FIG. 3B shows the 4-photon entangled state. FIG. 3C shows the 6-photon entangled state. FIG. 3D shows the 8-photon entangled state. FIG. 3E shows the 10-photon entangled state. FIG. 3F shows the 12-photon entangled state. FIG. 3G shows the 14-photon entangled state.

FIG. 4A is a plot illustrating the optimized average photon number for the two-mode squeezed vacuum state as a function of system efficiency.

FIG. 4B shows the corresponding squeezing parameter r for each point in FIG. 4A.

FIG. 5A is a plot illustrating phase sensitivity of the optimized TMSV state as a function of system efficiency, for a given an integration time. The equivalent shot noise and the TMSV limit are shown as well.

FIG. 5B is a plot illustrating the ratio of shot noise and phase sensitivity.

FIG. 6 is a plot showing TMSV probability distribution versus number of proton pairs and a fixed squeezing parameter r.

FIG. 7 is a plot showing the phase at which measurement is optimal versus number of photons at 81% system efficiency.

### DETAILED DESCRIPTION OF THE INVENTION

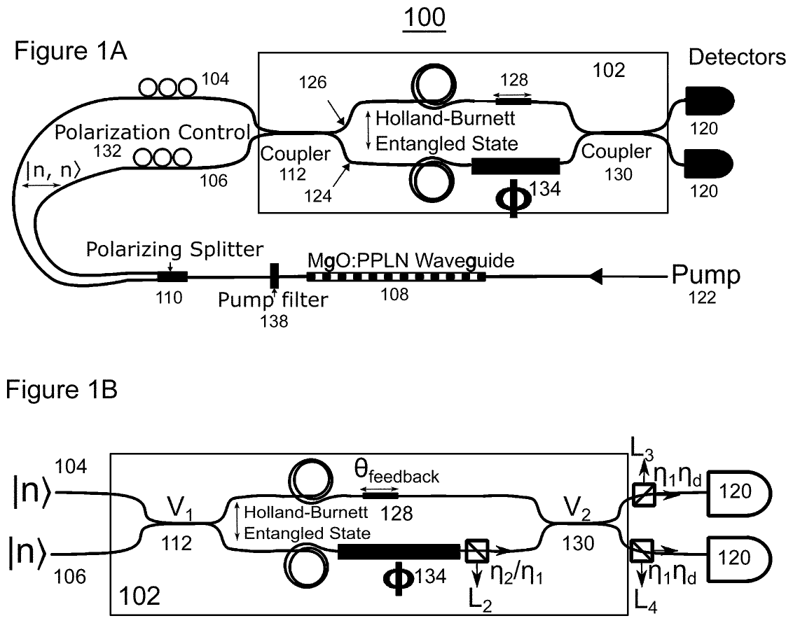

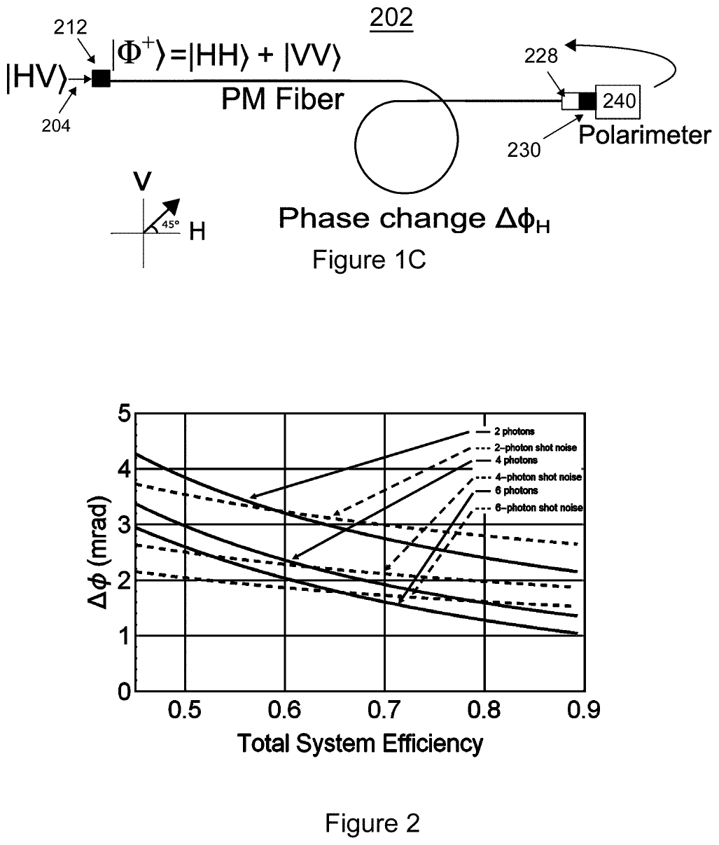

FIG. 1A is a schematic block diagram of an entanglement-enhanced interferometer system 100 using, as an example, two-mode squeezed vacuum (TMSV) and a Mach-Zehnder fiber based interferometer 102, with equal photon number inputs |n [symbol] in each port 104, 106 creating a Holland-Burnett state inside the interferometer 102. In this particular embodiment, a MgO:PPLN waveguide 108 acts as a degenerate photon pair source using type-II spontaneous parametric down-conversion, while the polarizing splitter 110 and 50:50 directional fiber coupler 112 act to create a Holland-Burnett path-entangled state. A polarization control device 132 is configured to rotate polarization of photons on one of the two paths 104 relative to the photons on the other of the two paths 106 in order to make photons indistinguishable.

The embodiment of FIG. 1A includes single photon detectors 120 to form a measurement system. The outputs of the Mach-Zehnder interferometer 102 are useful for applications requiring low photon flux such as measurement, biochemical sensing, and quantum computing and communication.

FIG. 1B shows an expanded portion of the block diagram of FIG. 1A showing the Mach-Zehnder interferometer 102 in more detail. The state experiences loss both inside the interferometer 102 (η1 and η2) and in the number-resolving detectors 120 (ηd). The internal loss mode L1 with loss 1-η1 is grouped into other losses for simplified analysis. Appendix A shows methods of modelling the interferometer of FIGS. 1A and 1B so that one can predict the sensor output given a set of imperfections.

The source of entangled photons is spontaneous parametric down-conversion in, for example, a periodically poled element, such as a periodically poled lithium niobate waveguide 108. This waveguide 108 converts pump 122 photons into photon pairs via type-II spontaneous parametric down-conversion (SPDC), which are spatially separated at a polarizing splitter 110. Rotating one polarization makes the photons indistinguishable prior to the first directional coupler (e.g. a 50:50 directional fiber coupler 112), which subsequently produces the entangled HB(N) state. “Indistinguishable” means that the photons are close enough to identical (other than polarization or other chosen aspect) to reliably achieve an entangled state, e.g., 80%-95% or more of the time. 90% is desirable and 95% is even better.

This is followed by a Mach Zehnder interferometer 102, with a bottom sensing branch 124, and a top reference branch 126. The feedback element 128 ensures that the two parts of the entangled state are matched in path length, allowing for an optimal measurement. A phase change can be induced by thermal expansion or strain in the fiber, or if using a photonic crystal fiber, a change in concentration of a diffuse gas in the fiber holes. In the embodiment of FIG. 1B, a portion of the top fiber varies in strain to keep the interferometer near its most sensitive operating point. A second 50:50 directional coupler 130 leads to the single photon detectors 120 which provide photon-number-resolved detection statistics, from which phase information is extracted.

Multiple experimental imperfections will deteriorate the performance of this quantum-enhanced sensor. Detection efficiency has perhaps been the most detrimental of these, but recent technological advances show promise in overcoming this obstacle.

Both superconducting transition-edge and nanowire sensors have demonstrated over 90% detection efficiency, some with inherent photon-number resolution. Other common detector metrics like dark count and timing jitter will also degrade performance. Fortunately, compared to the input photon flux of preferably at least 10⁶/s, typical dark counts (<10³/s) do not contribute any significant error. Additionally, timing jitter is not an issue since the time between pulses (a few ns) is much greater than typical timing jitters (several ps). Based on this technological review, we consider it demonstrated to have detectors with 90% efficiency and number resolution up to 6.

Another non-ideality is a finite degree of entanglement in the input state. The fidelity of Hong-Ou-Mandel interference in producing an entangled state depends on both the individual spectral purity and the joint indistinguishability of the interfering photons. Experimentally, the visibility is increased by applying narrow spectral filters 138 to the photon pair source, but at the expense of overall photon flux. Recent development in photon sources have demonstrated very high two-photon indistinguishabilities in a variety of sources. A practical implementation of our model based on a MgO:PPLN source can achieve 95% visibility while maintaining a photon flux of around 10⁶ /s. In order to maintain this visibility throughout the interferometer, polarization-maintaining fiber is necessary to minimize polarization mode dispersion, which could eliminate quantum interference.

FIG. 1C is a block diagram illustrating a common-path fiber version 202 of the interferometer 102 of FIG. 1. With an input 204 of two orthogonally polarized photons, a polarizing coupler 212 can create an entangled Bell state. When this coupler 212 is 45 degrees off-axis, it mixes the two polarization modes in the same way as a 50:50 coupler does for path entanglement. At the end of the sensor, a birefringent element 228 compensates for different path lengths in the birefringent fiber, and another polarizing coupler 230, 45 degrees off-axis, functions as the second beamsplitter. The detection module 240 performs photon number resolving detection based on polarization. With entanglement in polarization, this sensor demonstrates quantum-enhanced measurements of changes in birefringence Δϕ_{H} of the polarization-maintaining fiber.

The advantage of this common-mode configuration is that it automatically eliminates external phase noise in the system. All other modeling and math is agnostic to using this version of the sensor or the original.

With more photons, the off-axis coupler 212 at the input creates polarization-entangled Holland-Burnett states. The figure shows the Bell state because the states are equivalent.

FIG. 2 is a plot showing phase sensitivity of 2, 4, and 6-photon Holland-Burnett states as a function of total system efficiency (η η_{d}). The internal transmission in both modes η is varied while the sensor has 90% detection efficiency η_{d}, 95% Hong-Ou-Mandel visibility, and 2 mrad of phase noise. Each state's equivalent shot noise

$$\frac{1}{\sqrt{η {η}_{d} n}} ,$$

is also plotted for comparison. Each state has equal flux, assumed to be 8××10⁶/s, where 10 ms is the sensor integration time.

FIG. 2 shows quantum Craméer-Rao bounds from a 2, 4, and 6-photon Holland-Burnett state in the interferometer, compared to shot noise, as a function of internal transmission η₁=η₂=η, with our assumed realistic conditions of 90% detection efficiency, 95% visibility, and 2 mrad of phase noise. To better represent the sensor performance under practical circumstances, we have included an integration time of 10 ms, allowing measurements to be repeated m times, where m is the number of occurrences of that state in 10 ms. For FIG. 2, we have assumed an equal flux of each state of m =8×10⁶/s. Practically speaking, if using these states individually, the 4- and 6-photon states would be much less common than the 2-photon state, but for the sake of comparison all fluxes are identical here. Also for comparison, the equivalent shot noise

$$\frac{1}{\sqrt{m n η {η}_{d}}}$$

for each state is also plotted. The intersection of the quantum Craméer-Rao bound for each state with its equivalent shot noise is a good indication for how robust the state is against loss. At 90% internal transmission, the model shows a quantum advantage of 14%, 26%, and 28% beyond the shot noise limit for the 2, 4, and 6-photon states, respectively. These states do no better than shot noise at 66%, 70%, and 73% internal transmission, showing that higher-photon-number states are more sensitive to loss. Despite increased sensitivity to loss, the 4 and 6-photon states still maintain a quantum advantage in sensitivity for transmissions above around 0.7. Additionally, the minimum sensitivities still follow the scaling Δϕ∝N⁻¹, so they still have Heisenberg scaling.

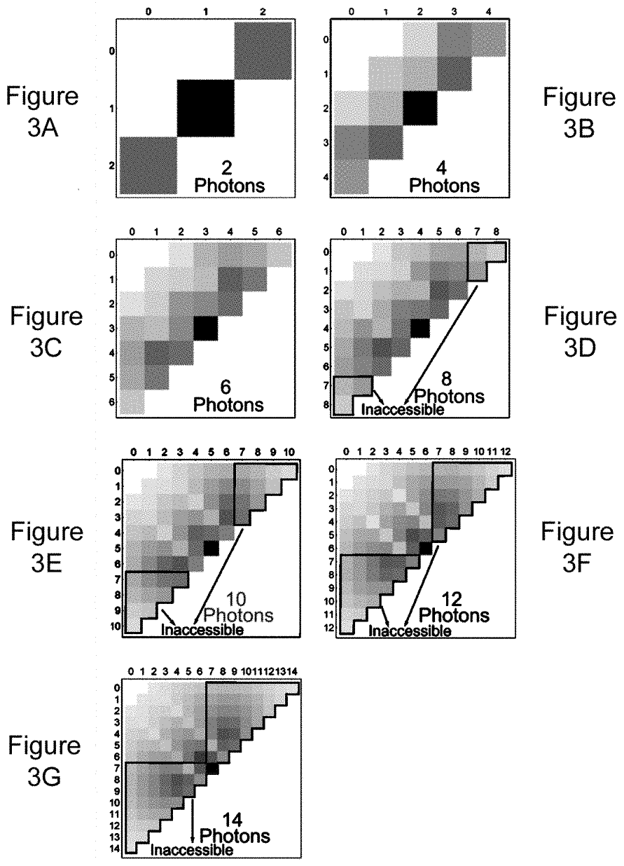

FIG. 3 shows matrix plots for the performance of Holland-Burnett states with up to 14 photons when put through the interferometer under realistic conditions. The Fisher information for each detection event shows which events give the most phase information. The red barriers correspond to events that the detectors, limited to 6 photons in number resolution, cannot resolve.

FIGS. 3A-3G illustrate the probabilities of detection events (nₐ photons in one branch and n_{b} photons in the other) and the associated Fisher Information from those events, for each Holland-Burnett state considered, when ηₙₑₜ=81% and θ_{feedback} is optimal for that state. An optimal measurement will extract the most information from detection events where nₐ≈n_{b}, and so detection events up to nₐ+n_{b}=12 are useful. FIG. 3A shows the 2-photon entangled state. FIG. 3B shows the 4-photon entangled state. FIG. 3C shows the 6-photon entangled state. FIG. 3D shows the 8-photon entangled state. FIG. 3E shows the 10-photon entangled state. FIG. 3F shows the 12-photon entangled state. FIG. 3G shows the 14-photon entangled state. It is not until the 10-photon entangled state of FIG. 3E that we see significant loss of information from limited number resolution in detectors.

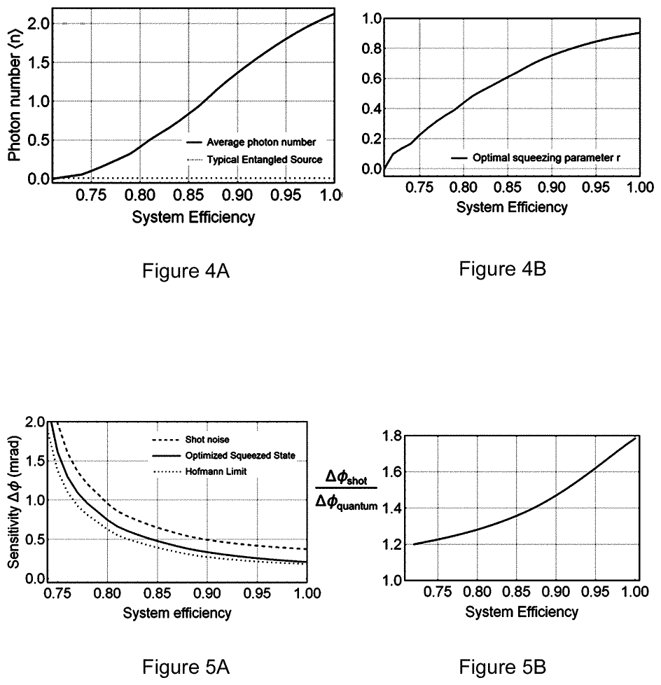

FIGS. 4A and 4B show results of optimizing a two-mode squeezed vacuum (TMSV) state's squeezing parameter to provide maximum phase information per photon, as a function of system efficiency. FIG. 4A shows results given an average photon number [symbol] n [symbol] .

FIG. 4B is a plot illustrating system efficiency results for various levels of squeezing parameter r. For comparison, the state's photon number per temporal mode 2 Sinh²(r) can be compared to that of a typical entangled source. The optimized TMSV can provide 50 times the flux at 81% system efficiency, or 210 times the flux at 100% efficiency.

When using the TMSV in the interferometer, there are competing effects that determine what squeezing parameter r is optimal. Results of this optimization are shown in FIG. 4B. In a 100% efficient system, rₒₚₜᵢₘₐₗ=0.903, and the corresponding photon number per mode [symbol] n [symbol] =2.13. We compare this to a typical entangled photon pair source, which intentionally limits [symbol] n [symbol] to about 0.01. The limited [symbol] n [symbol] ensures that, if any photons are produced, the likelihood of a single pair of photons (99%) is much higher than any other outcome. [symbol] n [symbol] is proportional to the photon flux of the entangled photon source, and so the increase in [symbol] n [symbol] for the TMSV source shows up to 213 times the photon flux of a typical entangled source. More realistically, near 81% system efficiency, that changes to 50 times the photon flux. This higher photon flux enables faster phase measurements, making the sensor much more practical to use.

The other notable feature in FIG. 4B is that rₒₚₜᵢₘₐₗ drops to 0 near 70% system efficiency. As seen earlier in FIG. 2, higher photon-number entangled states tend to lose their quantum advantage in sensitivity at progressively higher values of system efficiency. This means that it is no longer advantageous for an optimized TMSV state to include these states, and so rₒₚₜᵢₘₐₗ decreases with decreasing efficiency. Taking this to the limit, near 70% efficiency, only the 2-photon entangled state shows a quantum advantage, and so the optimization suppresses any likelihood of seeing higher states. With even lower efficiencies, it will not be advantageous at all to use the TMSV state in this manner.

FIG. 5A is a plot illustrating phase sensitivity of the optimized TMSV state as a function of system efficiency, for an integration time of 10 ms. The equivalent shot noise and the TMSV limit are shown as well.

FIG. 5B is a plot illustrating the ratio of shot noise and phase sensitivity, showing a quantum advantage varying from 20% to 78% with increasing system efficiency. At 81% system efficiency, the TMSV state provides a 28% phase sensitivity enhancement over shot noise.

Again, we have assumed an integration time of 10 ms to better represent the sensor's practical performance. By increasing both photon flux and phase information per photon, the phase sensitivity from the TMSV state scales exponentially with increasing system efficiency. When compared to shot noise, we notice two limits. Near 100% efficiency, we see a 78% sensitivity enhancement. In contrast, near 70% efficiency, this enhancement is only 20%. This 20% enhancement is close to the enhancement seen in the 2-photon state from FIG. 2. This is consistent, since near 70% efficiency, rₒₚₜᵢₘₐₗ is low enough that the TMSV is very likely to produce a 2-photon state, and so its performance should be close to that state.

Under realistic circumstances, we expect around 81% system efficiency, so we summarize results at this value to show how practical this sensor can be. At this value, the TMSV can provide a 500% flux enhancement over typical entangled-photon sources, and a 28% enhancement in phase sensitivity. Theoretically, the TMSV state has been shown to reach a limit on phase sensitivity, where

$$Δϕ = \frac{1}{\sqrt{{〈 n 〉}^{2} + 2 〈 n 〉}} .$$

When accounting for system losses in calculating this limit, this method of sensing comes within 14% of the limit near 100% efficiency. We attribute this to the fact that different entangled states have a different optimal phase at which measurement is optimal (Fisher Information is maximized). As a combination of all of these states, the TMSV would require θ_{feedback} to be set to multiple values simultaneously, which is not possible. Instead, a preferred θ_{feedback} was chosen as a function of system efficiency, which favored some entangled states over others.

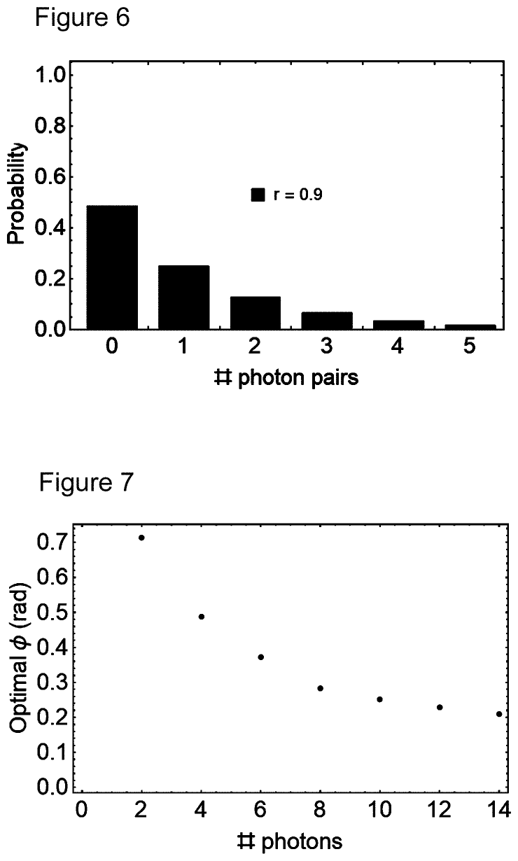

FIG. 6 is a plot showing TMSV probability distribution versus number of proton pairs and a fixed squeezing parameter r, here 0.9. TMSV is a superposition of multiple photon pairs. The probability distribution depends on the value of r. See Appendix A for more details.

$$P ( n ) = \frac{{tanh}^{2 n} ( r )}{{cosh}^{2} ( r )} , 〈 n 〉 = 2 {sinh}^{2} r$$

FIG. 7 is a plot showing optimal measurement versus number of photons at 81% system efficiency.

While the exemplary preferred embodiments of the present invention are described herein with particularity, those skilled in the art will appreciate various changes, additions, and applications other than those specifically mentioned, which are within the spirit of this invention.

What is claimed is:

1. A fiber optic entanglement-enhanced interferometry system comprising:
a source of correlated photons configured to two-mode squeezed vacuum (TMSV);
a polarizing coupler configured to separate the correlated photons into two fiber paths;
a polarization control device configured to rotate polarization of photons on one of the two fiber paths relative to the photons on the other of the two fiber paths in order to make photons indistinguishable;
a coupler configured to entangle indistinguishable photons; and
a polarization maintaining fiber-based interferometer configured to use the entangled photons as the input state.

2. The system of claim 1 wherein the source of correlated photons comprises a nonlinear element which facilitates spontaneous four-wave mixing.

3. The system of claim 2 wherein the nonlinear element comprises silica fiber.

4. The system of claim 1 wherein the source of correlated photons comprises a nonlinear element which facilitates spontaneous parametric downconversion.

5. The system of claim 4 wherein the nonlinear element comprises periodically poled lithium niobate.

6. The system of claim 5 wherein the nonlinear element comprises a lithium niobate waveguide.

7. The system of claim 1 wherein the interferometer is an optical fiber-based Mach-Zehnder interferometer.

8. The system of claim 1 wherein the coupler is a polarizing coupler 45 degrees off axis and wherein the interferometer is a common path interferometer and the entanglement between photons is accomplished in orthogonal polarizations.

9. The system of claim 8 wherein the polarization accomplishes Bell states.

10. The system of claim 8 wherein the coupler is a two-axis polarization maintaining fiber.

11. The system of claim 1 configured to achieve at least 28% improvement with at least 81% efficiency.

12. The system of claim 1 further comprising detectors configured to resolve photon number of the output state.

13. The system of claim 12 wherein the detectors comprise multiple single photon detectors connected with beam splitters to provide photon number resolution.

14. The system of claim 12 comprising 12 single photon detectors and configured to distinguish between 0,1, 2, 3, 4, 5, and 6 photons.

15. The system of claim 14 providing at least a 14% increase in phase sensitivity for a 2-photon entangled state over a similar system having a fiber-based interferometer which is not configured to use the entangled photons as the input state.

16. The system of claim 14 providing at least a 26% increase in phase sensitivity for a 4-photon entangled state over a similar system having a fiber-based interferometer which is not configured to use the entangled photons as the input state.

17. The system of claim 14 providing at least a 28% increase in phase sensitivity for a 6-photon entangled state over a similar system having a fiber-based interferometer which is not configured to use the entangled photons as the input state.

18. The fiber optic entanglement-enhanced interferometry method comprising the steps of:
providing correlated photons configured to two-mode squeezed vacuum (TMSV);
separating the correlated photons into two fiber paths with a polarizing coupler;
rotating polarization of photons on one of the two fiber paths relative to the photons on the other of the two fiber paths in order to make photons indistinguishable;
entangling indistinguishable photons; and
performing interferometry with the entangled photons as the input state.

19. The method of claim 18 further comprising the step of providing photon number resolution using single photon detectors connected with beam splitters.
